(19) United States
(12) Patent Application Publication
(10) Pub. No.: US 2026/0065119 A1
(43) Pub. Date: Mar. 5, 2026

(54) SYSTEM AND METHOD FOR HYBRID ANALYSIS OF QUANTUM AND CLASSICAL GENETIC ALGORITHMS

(71) Applicant: Accenture Global Solutions Limited, Dublin (IE)

(72) Inventors: Paulo André Viana DE ARAÚJO, Recife (BR); Saulo Cadete Santos MACHADO, Camaragibe (BR); Eric GORESCU, Sao Paulo (BR)

(21) Appl. No.: 18/819,943

(22) Filed: Aug. 29, 2024

(51) Int. Cl. G06N 10/60; G06N 3/126

(52) U.S. Cl. CPC G06N 10/60; G06N 3/126

(57) ABSTRACT

System and method for hybrid analysis of quantum and classical genetic algorithms is disclosed. The method includes, receiving an input bitstring, the input bitstring being an output of a genetic optimization module, processing the input bitstring to generate quantum processed bitstrings, mutating the input bitstring, mutating the quantum processed bitstrings as a function of the input bitstring and the mutated input bitstring, performing crossover on a combination of the mutated input bitstring and the mutated quantum processed bitstrings, and selecting a set of individuals from the quantum processed bit strings and output of the crossover. The method further includes, determining, after selecting the set of individuals, if the hybrid analysis is complete or incomplete based on predetermined criteria, returning, in response to the hybrid analysis being incomplete, the set of individuals as the input bit string, else, outputting the set of individuals as a result of the hybrid analysis.

### FIELD OF THE INVENTION

The present disclosure generally relates to the field of genetic algorithms and more particularly to a system and a method for hybrid analysis of quantum and classical genetic algorithms.

### BACKGROUND

Genetic Algorithm (GA) is a class of Evolutionally Algorithms (EAs) which is inspired by the process of natural selection. Typically, genetic algorithms are used to generate high-quality solutions to optimization and search problems by relying on biologically inspired operators such as mutation, crossover and selection. Genetic algorithm operates by maintaining a population of candidate solutions represented as chromosomes or individuals with genetic information. Such chromosomes are typically represented as strings of binary digits. Through iterative process of mutation, crossover and selection, genetic algorithms simulate the evolution of solutions over generations.

Further, quantum genetic algorithms (QGAs) are evolved to address the optimization and search problems more effectively in comparison with the genetic algorithms, particularly in complex and large search spaces. QGAs exploit the principles of from genetic algorithms with elements of quantum computing and leverages quantum bits (qubits) to encode and manipulate candidate solutions, allowing for simultaneous exploration of multiple potential solutions through quantum superposition and entanglement. Hence, QGAs offer the potential for exponential speedup over classical genetic algorithms for certain problems due to quantum parallelism and interference. While QGAs have advantages in addressing complex optimization and large search space problems, conventional QGAs have various limitations. For example, current quantum computers have limited qubit coherence times and high error rates, which often leads to inaccuracies in quantum operations, affecting the reliability and effectiveness of QGAs. Further, the limited qubit coherence times and the high error rates limit the advantages of the conventional QGAs in addressing real-world optimization problems.

### SUMMARY

This summary is provided to introduce a selection of concepts in a simple manner that is further described in the detailed description of the disclosure. This summary is not intended to identify key or essential inventive concepts of the subject matter nor is it intended for determining the scope of the disclosure.

A method for hybrid analysis of quantum and classical genetic algorithms is disclosed. The method includes, receiving an input bitstring, the input bitstring being an output of a genetic optimization module, processing the input bitstring to generate quantum processed bitstrings, mutating the input bitstring, mutating the quantum processed bitstrings as a function of the input bitstring and the mutated input bitstring, performing crossover on a combination of the mutated input bitstring and the mutated quantum processed bitstrings, and selecting a set of individuals from the quantum processed bit strings and output of the crossover.

Further disclosed is a non-transitory computer readable storage media coupled to a processor and having instructions storing thereon which, when executed by the processor, cause the processor to perform operations for hybrid analysis of quantum and classical generic algorithms. The operations include, receiving an input bitstring, the input bitstring being an output of a genetic optimization module, processing the input bitstring to generate a quantum processed bitstrings, mutating the input bitstring, mutating the quantum processed bitstrings as a function of the input bitstring and the mutated input bitstring, performing crossover on a combination of the mutated input bitstring and the mutated quantum processed bitstrings, and selecting a set of individuals from the quantum processed bit strings and output of the crossover.

Further disclosed is a system of for hybrid analysis of quantum and classical generic algorithms. The system includes, a non-transitory computer readable media storing instructions, and a processor. The processor is programmed to execute the instructions stored in the computer readable media to perform operations including, receiving an input bitstring, the input bitstring being an output of a genetic optimization module, processing the input bitstring to generate quantum processed bitstrings, mutating the input bitstring, mutating the quantum processed bitstrings as a function of the input bitstring and the mutated input bitstring, performing crossover on a combination of the mutated input bitstring and the mutated quantum processed bitstrings and selecting a set of individuals from the quantum processed bit strings and output of the crossover.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 depicts an exemplary block diagram of the system for hybrid analysis of quantum and classical genetic algorithms, in accordance with an embodiment of the present disclosure;

FIG. 2 depicts an exemplary block diagram of a genetic algorithm module for processing the initial bitstring to generate the input bitstring, in accordance with an embodiment of the present disclosure;

FIG. 3 depicts an exemplary quantum circuit with mutation module and crossover module, in accordance with an embodiment of the present disclosure;

FIG. 4 is process flow diagram illustrating a method of hybrid analysis of quantum and classical genetic algorithms, in accordance with an embodiment of the present disclosure;

FIG. 5 illustrates a schematic diagram of an exemplary generic classical processor system; and

FIG. 6 is a block diagram of an example quantum computing device.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

As described, quantum genetic algorithms (QGAs) are evolved to address the optimization and search problems more effectively in comparison with the genetic algorithms, particularly in complex and large search spaces. QGAs offer the potential for exponential speedup over classical genetic algorithms for certain problems due to quantum parallelism and interference. While QGAs have advantages in addressing complex optimization and large search space problems, conventional QGAs have various limitations. For example, current quantum computers have limited qubit coherence times and high error rates, which often leads to inaccuracies in quantum operations, affecting the reliability and effectiveness of QGAs. Further, the limited qubit coherence times and the high error rates limit the advantages of the conventional QGAs in addressing real-world optimization problems. These limitations underscore the ongoing necessity for hybrid analysis of quantum and classical generic algorithms for integrating populations and hence for selecting a set of individuals for solving a given problem.

Another limitation in QGA is that processors can only handle problems with a limited number of qubits. If the underlying problem requires use more qubits than available, then the problem cannot be solved. For example, a common current limit on qubits is 127, and a problem that requires more qubits is beyond the processing capability of such processors.

To address the one or more limitations, embodiments of the present disclosure disclose a system and a method for hybrid analysis of quantum and classical genetic algorithms for integrating populations and hence for selecting a set of individuals for solving a given problem. The set of individuals selected from the output of quantum and classical genetic algorithms facilitates for a dynamic interplay between exploration and exploitation while halving the number of qubits required to implement a quantum genetic algorithm, a more efficient and effective problem-solving. The quantum individuals facilitate a broad exploration of the solution space, while the classical individuals ensure the retention of the best solutions, thereby driving the population towards optimal problem-solving.

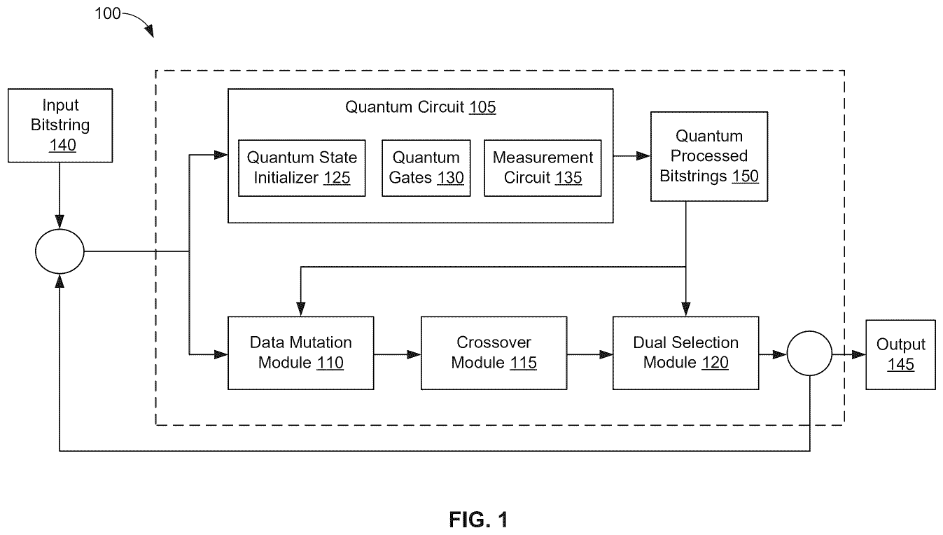

FIG. 1 depicts an exemplary block diagram of the system for hybrid analysis of quantum and classical genetic algorithms, in accordance with an embodiment of the present disclosure. As shown, the system 100 includes a quantum circuit 105, a dual mutation module 110, a crossover module 115 and a dual selection module 120. Further, the quantum circuit 105 includes a quantum state initializer 125, a gate 130 and a measurement circuit 135. It is to be noted that the system 100 may include, for example, a mainframe computer, a computer server or a network of computers with quantum computing capabilities. Accordingly, the system 100 includes one or more processors associated processing modules, interfaces and storage devices communicatively interconnected to one another through one or more communication means for communicating classical and quantum information. The storage associated with the system 100 may include volatile and non-volatile memory devices for storing information and instructions to be executed by the one or more processors and for storing temporary variables or other intermediate information during processing.

In one embodiment of the present disclosure, the system 100 receives an input bitstring 140, processes the input bitstring to generate quantum processed bitstrings, mutates the input bitstring, and mutates the quantum processed bitstrings as a function of the input bitstring and the mutated input bitstring. Then the system 100 performs crossover on a combination of the mutated input bitstring and the mutated quantum processed bitstrings and selects a set of individuals from the quantum processed bit strings and output of the crossover module 115. Upon selecting the set of individuals, the system 100 determines if the hybrid analysis is complete or incomplete based on predetermined criteria. In response to the hybrid analysis being incomplete, the system 100 feeds back the set of individuals as the input bit string and iterates the process until the hybrid analysis is complete. Once the hybrid analysis is complete, the system 100 provides the selected set of individuals as an output 145 for solving a given computation task. The set of individuals as described herein refers to a final population of candidate solutions to a given problem. The manner in which the system 100 performs the hybrid analysis of quantum and classical genetic algorithms to select the set of individuals is described below in further detail.

As described, the system 100 processes the input bitstring 140 using the quantum circuit 105 and other elements of the system 100 to generate a final population of candidate solutions to a computational task or problem. The input string 140 (input data) represents a computational task to be solved. For example, in some cases the system 100 may be configured to solve multiple computational tasks, and the input data may be data that specifies one of the multiple computational tasks. The input bitstring representing the computational task to be solved may specify one or more properties of the computational task, parameters associated with the computational task, for example the parameters over which an objective function representing the computational task is to be optimized, and one or more values of the parameters. Example computational tasks include, but are not limited to, optimization tasks, decision problems, counting problems or function problems. In some cases, the input bitstring 140 may include static input data and dynamic input data, for example, real-time input data.

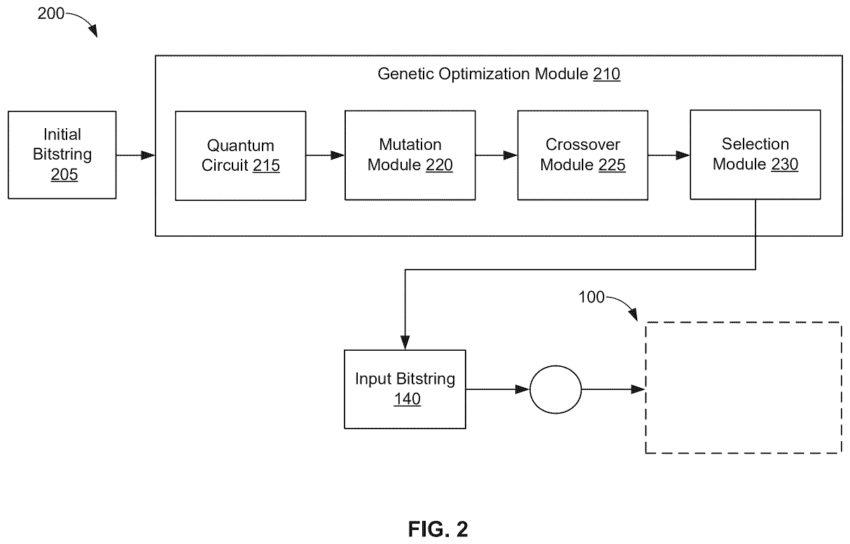

As described, the input bitstring 140 represents a computational task to be solved and the input bitstring 140 is fed to the system 100 for performing hybrid analysis by generating quantum population and classical population. In one embodiment of the present disclosure, the input bitstring 140 is one of an output of a classical genetic optimization module or an output of a quantum genetic optimization module. For example, the initial bitstring representing the computational task is fed to one of a classical genetic optimization module or a quantum genetic optimization module and the output of the classical genetic optimization module or the quantum genetic optimization module is fed as the input bitstring 140 to the system 100. FIG. 2 depicts an exemplary block diagram of a genetic algorithm module for processing the initial bitstring to generate the input bitstring, in accordance with an embodiment of the present disclosure. As shown, the initial bitstring 205, representing the computational task, is fed to the genetic optimization module 210. The genetic optimization module 210 is one of a classical genetic optimization module or a quantum genetic optimization module. Considering the quantum genetic optimization module, a quantum circuit 215 initializes a set of quantum bits (qubits) to represent the initial bitstring 205 in a quantum form, enabling quantum operations and computations. Once the qubits are initialized, the quantum circuit 215 performs quantum operations using quantum gates and measurement circuit (not shown in FIG. 2) and the output, bitstrings derived by measuring state of quantum information, is fed to a mutation module 220. Then the mutation module 220 performs mutations on the derived bitstrings to explore search space of potential solution. For example, the mutation module 220 randomly alters each derived bitstring and the randomness helps explore new potential solutions. Then a crossover module 225 combines genetic information from two parent solutions to create offerings. The two parent solutions are selected based on the fitness. Hence, the crossover module 225 creates one or more offspring solutions for each parent, the one or more offspring solutions having improved fitness and new characteristics. Then a selection module 230 selects one or more one or more solutions (the bit strings) based on the fitness score, and outputs the bitstring. The output bitstring from the genetic optimization module 210 is fed as the input bitstring 140 the system 100 for performing hybrid analysis of quantum and classical genetic algorithms.

As described, a set of qubits are initialed to represent the initial bitstring 205, the quantum information is measured to derive the bitstrings and then the process of mutation, crossover and selection is performed to generate the output bitstring. Alternatively, upon initializing the qubits and the process of mutation, crossover and selections are performed in the quantum state. Then the quantum information is measured to derive the bitstrings. In one embodiment of the present the genetic optimization module 210 performs a single iteration and outputs the bitstrings, and the output bitstring is fed as the input to the system 100.

Referring to FIG. 1, upon receiving the input bitstring 140, the quantum circuit 105 performs quantum operations on the input bitstring 140 to generate quantum processed bitstrings. Initially, the quantum state initializer 125 initializes a set of quantum bits (qubits) to represent the input bitstring 140 in a quantum form, enabling quantum operations and computations. As described, the input bitstring 140 is the classical bitstring and the quantum state initializer 125 processes the input bitstring 140 to generate quantized input data. For example, considering a classical input bitstring 140 as b=b₁, b₂, . . . bₙ, where each bᵢ is either “0” or “1”, the quantum state initializer 125 initializes n qubits to encode the input bitstring 140. Further, if bᵢ=0 then the quantum state initializer 125 initializes i^{th} qubit to |0 [symbol] , and if bᵢ=1 then the quantum state initializer 125 initializes i^{th} qubit to |1>.

Then the quantum gates 130 are used to manipulate the quantum state of the qubits. In one embodiment, Hadamard (H) gate is used to create superpositions. However, other quantum gates such as but not limited to Controlled Gates, Phase Gates, and Entangling Gates may be used for creating superpositions, entanglement, and other quantum states. It is to be noted that the quantum gates 130 may be applied sequentially or in parallel, depending on the quantum circuit and the desired transformation of the quantum state.

Upon generating the superpositions using the quantum gates 130, for example Hadamard (H) gate, the measurement circuit 135 performs measurements on the qubits. Referring to the example, the measurement circuit 135 performs measurements on all the n qubits and each qubit collapses to either |0 [symbol] or |1 [symbol] based on the quantum state, for example based on the probability amplitudes of |0 [symbol] and |1 [symbol] in the superposition state of the qubit. Hence, the output of the measurement circuit 135 is the quantum processed bitstrings 150 and the quantum processed bitstrings 150 are also referred to as a first population as a quantum generated version of the input bitstring 140 in generic bitstring format.

As described, the quantum circuit 105 receives the input bitstring 140 and generates the quantum processed bitstrings 150. The quantum processed bitstrings 150 are fed to the dual mutation module 110 for further processing.

In one embodiment of the present disclosure, the dual mutation module 110 receives both the input bitstring 140 and the quantum processed bitstring 150 and performs several mutations. That is, the dual mutation module 110 performs one classical mutation (a first mutation) and one quantum mutation (a second mutation).

The first mutation is on the input bitstring 140 to generate mutated input bitstring by introducing random changes to the input bitstring 140 and generates the mutated input bitstring. In one embodiment, for the classical mutation, a random individual from the classical population (individual), a random individual from the measured quantum population, and the best individual from the classical population (best) are selected for creating the mutant individual.

The second mutation is on the quantum processed bitstrings 150 as a function of the input bitstring 140 and the mutated input bitstring. Hence, the input to the dual mutation module 110 are the input bitstring 140 and the quantum processed bitstrings 150.

On receiving the input bitstring 140, the dual mutation module 110 mutates the input bitstrings 140 by introducing random changes to the input bitstring 140 and generates the mutated input bitstring. Further, the dual mutation module 110 mutates the quantum processed bitstrings 150 as a function of the input bitstring 140 and the mutated input bitstring. For example, based the input bitstring 140, the dual mutation module 110 mutates the quantum processed bitstrings 150 and hence the input bitstring 140 influences mutation process.

Similarly, mutating the quantum processed bitstrings 150 as a function of the mutated input bitstring creates mutated bitstrings which are influenced by the mutated input bitstring. Hence, mutation of the quantum processed bitstrings 150 as a function of the input string 140 and the mutated input bitstrings ensure the preservation of high-quality solutions throughout the evolutionary process. The quantum processed bitstrings 150 facilitate a broad exploration of the solution space, while the input bitstring 140 and the mutated input bitstring ensure the retention of the best solutions, thereby driving the population towards optimal problem-solving.

In one embodiment, the quantum bitstring is mutated by quantum circuit of size n and applying H-gates to all qubits in 130. Further, a rotation strategy with parameterized Ry(θ) gates is applied. Furthermore, the classical population is used to determine how the rotation strategy will function. To determine the angle, a random individual and the best individual (highest fitness) from the classical population are selected, each bit of the selected individual and the best individual is summed and the difference (dist_center) between them is calculated, as shown in equation (1) below.

$$dist\_center = \sum {ind}_{i} - \sum {ind}_{best} \qquad ( 1 )$$

Then the value is adapted to angles ρ of a circle by multiplying the value by a factor of 2π/m, where m is the number of genes, as shown in equation (2).

$${ρ}_{i} = \frac{2 π}{m} \qquad ( 2 )$$

Further, a value of (π/2)m is selected for an auxiliary angle θ, wherein the angle θ is the angle calculated from the previous generation.

$${θ}_{0} = \frac{π}{2} m$$

Then, for each individual in the population, a new angle is calculated.

$${∅}_{i} = αβγ = - sign ( sin ( {θ}_{i} - {ρ}_{i} ) ) \frac{Δ rot}{c} \vert fitness ( {ind}_{i} ) - fitness ( {ind}_{best} ) \vert \qquad ( 3 )$$

α—defines the direction of the rotation, β—defines the predefined interval wherein the rotation will occur, C—is the integer defined heuristically, and γ—defines the distance that the rotation will occur, being proportional to the distance between the current individual and the best individual of the generation.

The output of the dual mutation module 110 is a mutant population generated by the input bitstring and the quantum processed bitstrings and this mutant population is fed to the crossover module 115. Equation (4) depicts the output of the mutation module 110.

$${mutant}_{i} = {ind}_{i} XOR {ind}_{q {uantum}_{i}} XOR {ind}_{best} \qquad ( 4 )$$

In one embodiment of the present disclosure, the crossover module 115 performs crossover on a combination of the mutated input bitstring and the mutated quantum processed bitstrings. The crossover module 115 combines genetic information from the input bitstring and the mutated quantum processed bitstrings and creates offsprings (bitstrings) that inherit the characteristics from both the parents. Considering the mutated input bitstring and the mutated quantum processed bitstrings as two parents, a crossover point is determined where the crossover operation takes place. The crossover point divides the mutated input bitstring and the mutated quantum processed bitstring into segments that is exchanged to create an output bitstring (offspring). It is to be noted that the crossover point is randomly selected to ensure genetic diversity. As described, the crossover module 115 considers classical and mutant population and select genes from each considering the crossover rate to create a trial population (second population). According to the crossover point, the module selects a gene from the mutant if the value exceeds the crossover point, otherwise, the module selects a gene from the classical individual. The output of the crossover module 115, a second population, is fed to the dual selection module 120.

In one embodiment of the present disclosure, the dual selection module 120 selects a set of individuals from the quantum processed bit strings 150 (the first population) and output of the crossover module 115 (the second population). The dual selection module 120 determines the one or more individuals, from the first population and the second population, with higher fitness among other individuals within the group, thereby evolving better solutions over successive generations. To select the set of individuals, the dual selection module 120 evaluates fitness of each individual in the first population and the second population based on a fitness function that quantifies how well the individual solves the initial problem. Then the dual selection module 120 selects the set of individuals with higher fitness values to solve the initial problem or to create next generation of solutions during further iterations. It is to be noted that the dual selection module 120 may implement selection methods such as fitness proportionate selection method, tournament selection method, rank-based selection method, etc. to select the set of individuals from the first population and the second population.

In one embodiment of the present disclosure, after selecting the set of individuals, the dual selection module 120 is further configured to determine if the hybrid analysis is complete or incomplete based on predetermined criteria. In one embodiment, the predetermined criteria include a predetermined number of iterations and a predefined error rate. Based on the predetermined criteria, the dual selection module 120 either terminates the analysis process and provides the set of individuals as the output solution to the initial problem or performs iterations with the selected set of individuals as the input bitstring 140 to determine the best possible solutions to the initial problem. For example, considering predetermined criteria being the predetermined number of iterations, the dual selection module 120 feeds back the selected set of individuals as the input bitstring 140 to the quantum circuit 105 and the dual mutation module 110 as shown in FIG. 1 and iterates the analysis process. When the number predetermined number of iterations are performed, the dual selection module 120 terminates the process and provide the final set of individuals (final population) 145 as the output solution. In another example, considering the predetermined criteria being the predefined error rate, the dual selection module 120 computes the error rate for the selected set of individuals and if the error rate is greater than or equal to the predefined error rate, then the dual selection module 120 feeds back the selected set of individuals as the input bitstring 140 to the quantum circuit 105 and the dual selection module 110 as shown in FIG. 1 and iterates the analysis process. If the error rate is less than the predefined error rate, the dual selection module 120 terminates the process and provide the final set of individuals (final population) 145 as the output solution. In one embodiment, the predetermined criteria for determining if the hybrid analysis is complete or incomplete may include but not limited to fitness threshold, convergence of fitness values, time, criteria defined for quality of the solution, etc. Further, the decision logic may be implemented using a dedicated module coupled to the dual selection module 120.

As described, the system 100 performs the hybrid analysis of quantum and classical genetic algorithms and integrates classical and quantum generated populations to select a set of fittest individuals for a given computation task. The system 100 initially processes the input bitstring 140 to generate the quantum processed bitstring 150 (the first population), mutates the input bitstring 140, and the quantum processed bitstrings as a function of the input bitstring and the mutated input bitstring. Then the system 100 performs the crossover to generate the second population and selects the set of individuals from the first population and the second population.

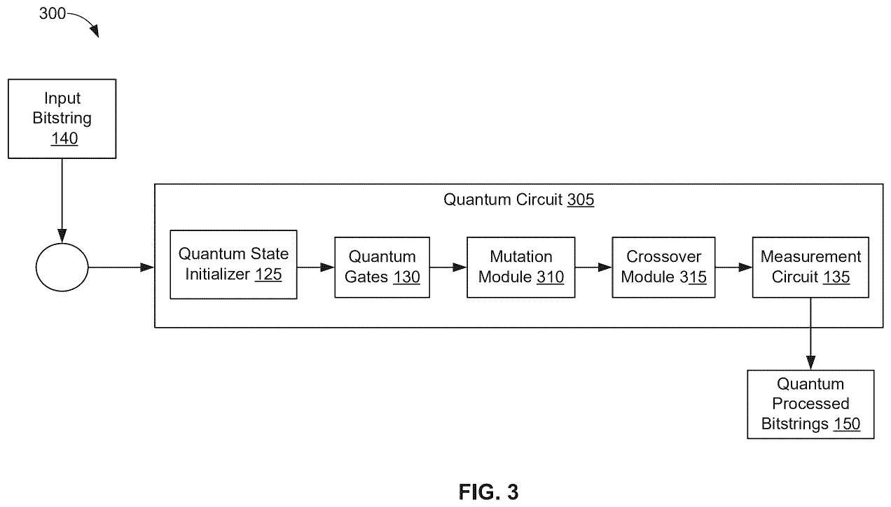

In one embodiment of the present disclosure, the quantum circuit 105 is further configured to perform mutation and crossover on the qubits to generate the quantum processed bitstring 150. FIG. 3 depicts an exemplary quantum circuit with mutation module and crossover module, in accordance with an embodiment of the present disclosure. As shown, the quantum circuit 305 is similar to the quantum circuit 105 depicted in FIG. 1. However, the quantum circuit 305 also includes a mutation module 310 and a crossover module 315 in addition to the quantum state initializer 125, the quantum gates 130 and the measurement circuit 135. As described, on receiving the input bitstring 140, the quantum state initializer 125 initializes the qubits to covert the input bitstring 140 into qubits and the quantum gates 130 performs superposition. In one embodiment of the present disclosure, the mutation module 310 probabilistically alters the quantum sates to explore different potential solutions. The mutation module 310 applies quantum gate operations to manipulate the qubits and introduce mutation. For example, the mutation module 310 may flip the state of the qubit (analogous to flipping a bit in the classical mutation) or may change the sign of the probability amplitude to manipulate the qubits. Then the crossover module 315 performs crossover by combining quantum states from different qubits to create new quantum states. In one embodiment, the crossover module 315 uses quantum gates such as Controlled-NOT (CNOT) gates for entangling qubits from different quantum states to create new entangled states. Then the measurement circuit 135 performs measurements on all the qubits and each qubit collapses to either |0 [symbol] or |1 [symbol] based on the quantum state, for example based on the probability amplitudes of |0 [symbol] and |1 [symbol] in the superposition state of the qubit. Hence, the output of the measurement circuit 135 is the quantum processed bitstrings 150 which is fed to the dual mutation module 110 and the dual selection module 120, as shown in FIG. 1. In this implementation, a single iteration of mutation and crossover is performed on the qubits to explore possible solutions to the given problem.

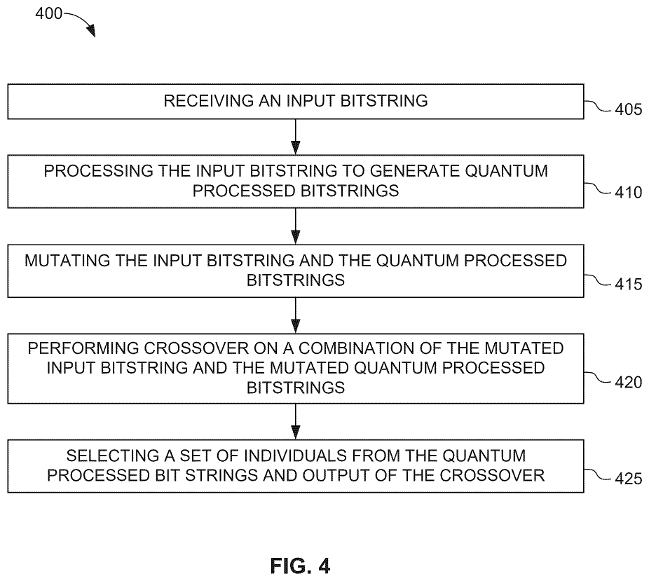

FIG. 4 is a process flow diagram illustrating a method of hybrid analysis of quantum and classical genetic algorithms, in accordance with an embodiment of the present disclosure. At step 405, the system 100 receives an input bitstring 140, the input bitstring 140 being an output of a genetic optimization module 210. For example, the genetic optimization module 210 receives an initial bitstring 205 representing a computational task and performs one of classical operations or quantum operations to generate output bitstring which is fed as an input bitstring to the system 100.

At step 410, the system 100 processes the input bitstring 140, using the quantum circuit 105, to generate the quantum processed bitstrings 150. In one embodiment, the quantum circuit 105 initializes the qubits, performs quantum operations and measurements to generate the quantum processed bitstring 150. In another embodiment, the quantum circuit 305 initializes the qubits, performs quantum operations, performs mutation and crossover in the quantum domain and then performs measurements to generate the quantum processed bitstrings 150. The quantum processed bitstring 150 is fed as an input to the dual mutation module 110.

At step 415, the dual mutation module 110 mutates the input bitstring 140 and the quantum processed bitstrings 150. In one embodiment, the mutation module 110 mutates the input bitstring to generate the mutated input bitstring and mutates the quantum processed bitstrings 150 as a function of the input bitstring 140 and the mutated input bitstring.

At step 420, the crossover module 115 performing crossover on a combination of the mutated input bitstring and the quantum processed bitstrings 150. The crossover module 115 combines genetic information from the input bitstring and the mutated quantum processed bitstrings and creates offsprings (bitstrings) that inherit the characteristics from both the parents.

At step 425, the dual selection module 120 selects a set of individuals from the quantum processed bit strings (the first population) and the output of the crossover module 115 (the second population). The dual selection module 120 determines the one or more individuals, from the first population and the second population, with higher fitness among other individuals within the group, thereby evolving better solutions over successive generations. To select the set of individuals, the dual selection module 120 evaluates fitness of each individual in the first population and the second population based on a fitness function that quantifies how well the individual solves the initial problem. Then the dual selection module 120 selects the set of individuals with higher fitness values to solve the initial problem or to create next generation of solutions during further iterations.

In one embodiment of the present disclosure, after selecting the set of individuals, the system 100 determines if the hybrid analysis is complete or incomplete based on the predetermined criteria. If the hybrid analysis incomplete, the set of individuals are returned or fed back as the input bitstring for further iteration and analysis. Else (if the hybrid analysis is complete), the selected set of individuals are outputted as a result of the hybrid analysis of the quantum and classical genetic algorithms.

The above methodology provides a technical solution to the technical problems of prior art system. As noted above, the number of qubits that the processor can handle is limited, and problems that require more qubits than available cannot be solved. The above methodology uses half the number of qubits due to the use of both generic bits and qbits. For example, if a problem to be solved needed 20 qubits in the prior art, the above methodology use of both generic bits and qbits would only require 10 qubits to solve the same problem. If the problem needed 200 qubits in the prior art and the processor was limited to 127 qubits then the problem could not be solved due to insufficient qubits, but the above methodology could solve the problem using only 100 qubits.

In the above descriptions, the qubit to generic bit ratio is 50-50, thus needing only half the qubits. However, the invention is not so limited, and the ratio is adjustable. As described, the method and system disclosed in the present disclosure merges classical and quantum population when exploring the solution space. The merger allows for an elite of individuals that remember the best solutions (classical) and new explorer individuals that can enable to find other solutions (quantum). The split between classical and quantum population sizes is configurable, as each individual (either classical or quantum) represent a possible solution to the problem.

As described, the system and the method disclosed in the present disclosure hybrid analysis of the quantum and classical genetic algorithms and integrates classical and quantum populations to select a set of fittest individual to solve a given computational task. This dual-unit structure of the population (integration of the first and the second population) allows for a dynamic interplay between exploration and exploitation while halving the number of qubits required to implement a quantum genetic algorithm, a more efficient and effective problem-solving. The quantum individuals facilitate a broad exploration of the solution space, while the classical individuals ensure the retention of the best solutions, thereby driving the population towards optimal problem-solving.

Further, by integrating classical elements into the population and using the classical elements to store the elite of the best results, the proposed system and method reduces the dependency on quantum resources. This makes the system and method more suitable for implementation on current quantum computers, expanding the practical applicability of quantum genetic algorithms.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

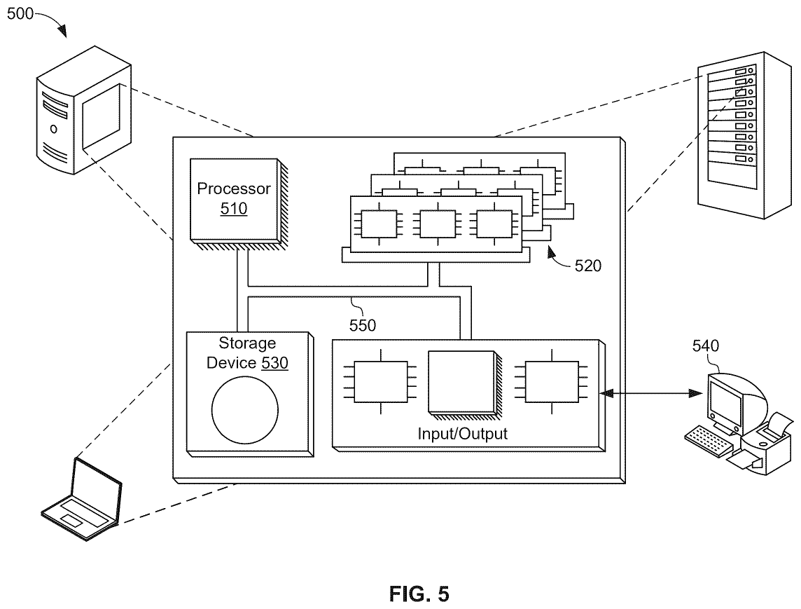

FIG. 5 illustrates a schematic diagram of an exemplary generic classical processor system. The system 500 can be used for the classical operations described in this specification according to some implementations. The system 500 is intended to represent various forms of digital computers, workstations, servers, blade servers, mainframes, and other appropriate computers. The components shown, their connections and relationships, and their functions, are exemplary only, and do not limit implementations of the inventions described and/or claimed in this document. The system 500 includes a processor 510, a memory 520, a storage device 530, and an input/output device 540. Each of the components 510, 520, 530, and 520 are interconnected using a system bus 550. The processor 510 may be enabled for processing instructions for execution within the system 500. In one implementation, the processor 510 is a single-threaded processor. In another implementation, the processor 510 is a multi-threaded processor. The processor 510 may be enabled for processing instructions stored in the memory 520 or on the storage device 530 to display graphical information for a user interface on the input/output device 540. In one implementation, the memory 520 is a computer-readable medium. In one implementation, the memory 520 is a volatile memory unit. In another implementation, the memory 520 is a non-volatile memory unit. The storage device 530 may be enabled for providing mass storage for the system 500. In one implementation, the storage device 530 is a computer-readable medium. In various different implementations, the storage device 530 may be a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

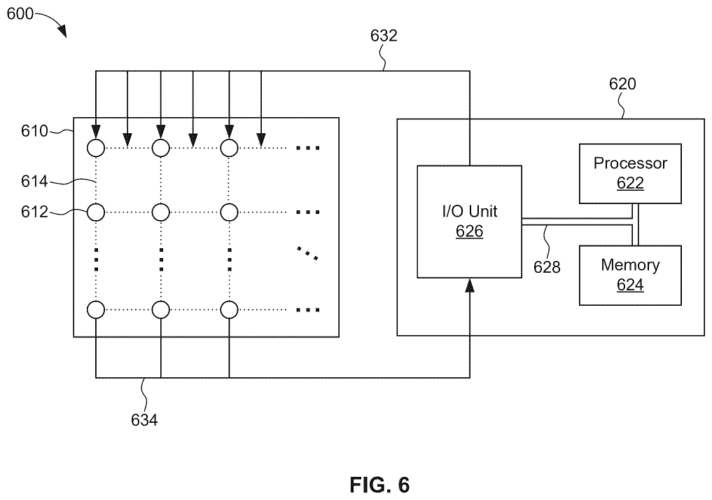

FIG. 6 is a block diagram of an example quantum computing device. The quantum computing device 600 can be used to perform the quantum computation operations described in this specification according to some implementations. The quantum computing device 600 is intended to represent various forms of quantum computing devices. The components shown here, their connections and relationships, and their functions, are exemplary only, and do not limit implementations of the inventions described and/or claimed in this document. The quantum computing device 600 includes a qubit assembly 610 and a control and measurement system 620. The qubit assembly includes multiple qubits, for example, qubit 612, that are used to perform algorithmic operations or quantum computations. While the qubits shown in FIG. 6 are arranged in a rectangular array, this is a schematic depiction and is not intended to be limiting. The qubit assembly 610 also includes adjustable coupling elements, for example, coupler 614, that allow for interactions between coupled qubits. In the schematic depiction of FIG. 6, each qubit is adjustably coupled to each of its four adjacent qubits by means of respective coupling elements. However, this is an example arrangement of qubits and couplers, and other arrangements are possible, including arrangements that are non-rectangular, arrangements that allow for coupling between non-adjacent qubits, and arrangements that include adjustable coupling between more than two qubits.

Each qubit can be a two-level quantum system or device having levels representing logical values of 0 and 1. The specific physical realization of the multiple qubits and how they interact with one another is dependent on a variety of factors including the type of the quantum computing device 600 or the type of quantum computations that the quantum computing device 600 is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by initializing the qubits in a selected initial state and applying a sequence of quantum logic gates to the qubits. Example quantum logic gates include single-qubit gates, for example, Pauli-X, Pauli-Y, Pauli-Z (also referred to as X, Y, Z), Hadamard and S gates, two-qubit gates, e.g., controlled-X, controlled-Y, controlled-Z (also referred to as CX, CY, CZ), and gates involving three or more qubits, e.g., Toffoli gates. The quantum logic gates can be implemented by applying control signals 632 generated by the control and measurement system 620 to the qubits and to the couplers.

For example, in some implementations the qubits in the qubit assembly 610 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, for example, when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 632 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, for example, using a quantum observable such as Z, using respective control signals 634. The measurements cause readout signals 634 representing measurement results to be communicated back to the measurement and control system 620. The readout signals 634 may include RF, microwave, or optical signals depending on the physical scheme for the quantum computing device 600 and/or the qubits. For convenience, the control signals 632 and readout signals 634 shown in FIG. 6 are depicted as addressing only selected elements of the qubit assembly (i.e. the top and bottom rows), but during operation the control signals 632 and readout signals 634 can address each element in the qubit assembly 610.

The control and measurement system 620 is an example of a classical computer system that can be used to perform various operations on the qubit assembly 610, as described above. The control and measurement system 620 includes one or more classical processors, e.g., classical processor 622, one or more memories, for example, memory 624, and one or more I/O units, for example, I/O unit 626, connected by one or more data buses, for example, bus 628. The control and measurement system 620 can be programmed to send sequences of control signals 632 to the qubit assembly, for example to carry out a selected series of quantum gate operations, and to receive sequences of readout signals 634 from the qubit assembly, for example as part of performing measurement operations.

The processor 622 is configured to process instructions for execution within the control and measurement system 620. In some implementations, the processor 622 is a single-threaded processor. In other implementations, the processor 622 is a multi-threaded processor. The processor 622 is capable of processing instructions stored in the memory 624.

The memory 624 stores information within the control and measurement system 620. In some implementations, the memory 624 includes a computer-readable medium, a volatile memory unit, and/or a non-volatile memory unit. In some cases, the memory 624 can include storage devices capable of providing mass storage for the system 620, for example a hard disk device, an optical disk device, a storage device that is shared over a network by multiple computing devices (a cloud storage device), and/or some other large capacity storage device.

The input/output device 626 provides input/output operations for the control and measurement system 620. The input/output device 626 can include D/A converters, A/D converters, and RF/microwave/optical signal generators, transmitters, and receivers, whereby to send control signals 632 to and receive readout signals 634 from the qubit assembly, as appropriate for the physical scheme for the quantum computer. In some implementations, the input/output device 926 can also include one or more network interface devices, e.g., an Ethernet card, a serial communication device, e.g., an RS-232 port, and/or a wireless interface device, e.g., an 802.11 card. In some implementations, the input/output device 626 can include driver devices configured to receive input data and send output data to other external devices, e.g., keyboard, printer and display devices.

Although an example control and measurement system 620 has been depicted in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the digital and/or quantum subject matter and the digital functional operations and quantum operations described in this specification can be implemented in digital electronic circuitry, suitable quantum circuitry or, more generally, quantum computational systems, in tangibly-embodied digital and/or quantum computer software or firmware, in digital and/or quantum computer hardware, including the structures disclosed in this specification and their structural equivalents, or in combinations of one or more of them. The term “quantum computing device” may include, but is not limited to, quantum computers, quantum information processing systems, quantum cryptography systems, or quantum simulators.

Implementations of the digital and/or quantum subject matter described in this specification can be implemented as one or more digital and/or quantum computer programs, i.e., one or more modules (or engines) of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits, or a combination of one or more of them. Alternatively, or in addition, the program instructions can be encoded on an artificially generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A digital and/or quantum computer program may, but need not, correspond to a file in a file system. A program can be stored in a portion of a file that holds other programs or data, e.g., one or more scripts stored in a mark-up language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network.

A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers to be “configured to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum processors or both, or any other kind of central digital and/or quantum processing unit. Generally, a central digital and/or quantum processing unit will receive instructions and digital and/or quantum data from a read-only memory, a random-access memory, or quantum systems suitable for transmitting quantum data, e.g. photons, or combinations thereof.

The essential elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include or be operatively coupled to receive digital and/or quantum data from or transfer digital and/or quantum data to, or both, one or more mass storage devices for storing digital and/or quantum data, e.g., magnetic, magneto-optical disks, optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more non-transitory machine-readable storage media, and that are executable on one or more digital and/or quantum processing devices. The systems described in this specification, or portions of them, can each be implemented as an apparatus, method, or system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method of hybrid analysis of quantum and classical genetic algorithms, comprising:
receiving an input bitstring, the input bitstring being an output of a genetic optimization module;
processing the input bitstring to generate quantum processed bitstrings;
mutating the input bitstring;
mutating the quantum processed bitstrings as a function of the input bitstring and the mutated input bitstring;
performing crossover on a combination of the mutated input bitstring and the mutated quantum processed bitstrings; and
selecting a set of individuals from at least the quantum processed bit strings and output of the crossover.

2. The method of claim 1, further comprising:
determining, after selecting the set of individuals, if the hybrid analysis is complete or incomplete based on predetermined criteria;
returning, in response to the hybrid analysis being incomplete, the set of individuals as the input bit string;
outputting, in response to the hybrid analysis being complete, the selected set of individuals as a result of the hybrid analysis of the quantum and classical genetic algorithms.

3. The method of claim 2, wherein the predetermined criteria are either a predetermined number of iterations or a predefined error rate.

4. The method of claim 1, wherein processing the input bitstring comprises:
converting the input bitstring to qubits;
placing the qubits in superposition;
measuring quantum information based on state of the qubits in superposition to generate the quantum processed bit strings.

5. The method of claim 1, wherein processing the input bitstring comprises:
converting the input bitstring to qubits;
placing the qubits in superposition;
mutating the qubits in superposition;
performing crossover on the mutated qubits in superposition; and
measuring quantum information based on state of the qubits in superposition to generate the quantum processed bit strings.

6. The method of claim 1, wherein the input bitstring is one of an output of a classical genetic optimization module or an output of a quantum genetic optimization module.

7. A non-transitory computer readable storage media coupled to a processor and having instructions storing thereon which, when executed by the processor, cause the processor to perform operations for hybrid analysis of quantum and classical generic algorithms, the operations comprising:
receiving an input bitstring, the input bitstring being an output of a genetic optimization module;
processing the input bitstring to generate a quantum processed bitstrings;
mutating the input bitstring;
mutating the quantum processed bitstrings as a function of the input bitstring and the mutated input bitstring;
performing crossover on a combination of the mutated input bitstring and the mutated quantum processed bitstrings; and
selecting a set of individuals from at least the quantum processed bit strings and output of the crossover.

8. The non-transitory computer readable media of claim 7, further comprising:
determining, after the selecting the set of individuals, if the hybrid analysis is complete or incomplete based on predetermined criteria;
returning, in response to the hybrid analysis being incomplete, the set of individuals as the input bit string;
outputting, in response to the hybrid analysis being complete, the selected set of individuals as a result the hybrid analysis of the quantum and classical genetic algorithms.

9. The non-transitory computer readable media of claim 8, wherein the predetermined criteria are either a predetermined number of iterations or a predefined error rate value is satisfied.

10. The non-transitory computer readable media of claim 7, wherein processing the input bitstring comprises:
converting the input bitstring to qubits;
placing the qubits in superposition;
measuring quantum information based on state of the qubits in superposition to generate the quantum processed bit strings.

11. The non-transitory computer readable media of claim 7, wherein processing the input bitstring comprises:
converting the input bitstring to qubits;
placing the qubits in superposition;
mutating the qubits in superposition;
performing crossover on the mutated qubits in superposition; and
measuring quantum information based on state of the qubits in superposition to generate the quantum processed bit strings.

12. The non-transitory computer readable media of claim 7, wherein the input bitstring is one of an output of a classical genetic optimization module or an output of a quantum genetic optimization module.

13. A system of for hybrid analysis of quantum and classical generic algorithms, the system comprising:
a non-transitory computer readable media storing instructions;
a processor programmed to execute the instructions stored in the computer readable media to perform operations including:
receiving an input bitstring, the input bitstring being an output of a genetic optimization module;
processing the input bitstring to generate quantum processed bitstrings;
mutating the input bitstring;
mutating the quantum processed bitstrings as a function of the input bitstring and the mutated input bitstring;
performing crossover on a combination of the mutated input bitstring and the mutated quantum processed bitstrings; and
selecting a set of individuals from at least the quantum processed bit strings and output of the crossover.

14. The system of claim 13, the operations further comprising:
determining, after selecting the set of individuals, if the hybrid analysis is complete or incomplete based on predetermined criteria;
returning, in response to the hybrid analysis being incomplete, the set of individuals as the input bit string;
outputting, in response to the hybrid analysis being complete, the selected set of individuals as a result of the hybrid analysis of the quantum and classical genetic algorithms.

15. The system of claim 13, wherein processing the input bitstring comprises:
converting the input bitstring to qubits;
placing the qubits in superposition;
measuring quantum information based on state of the qubits in superposition to generate the quantum processed bit strings.

16. The system of claim 13, wherein processing the input bitstring comprises:
converting the input bitstring to qubits;
placing the qubits in superposition;
mutating the qubits in superposition;
performing crossover on the mutated qubits in superposition; and
measuring quantum information based on state of the qubits in superposition to generate the quantum processed bit strings.

17. The system of claim 13, wherein the input bitstring is one of an output of a classical genetic optimization module or an output of a quantum genetic optimization module.
